(19) United States
(12) Patent Application Publication
(10) Pub. No.: US 2008/0029989 A1
(43) Pub. Date: Feb. 7, 2008

(54) Removable fender assembly for a work vehicle

(76) Inventor: Stephen Griffiths, Thorold (CA)

Correspondence Address: DEERE & COMPANY, ONE JOHN DEERE PLACE, MOLINE, IL, 61265, US

(21) Appl. No.: 11/499,140

(22) Filed: Aug. 4, 2006

(51) Int. Cl. B62D 25/18

(52) U.S. Cl. 280/154

(57) ABSTRACT

A work vehicle includes a frame and a fender assembly. The fender assembly includes a fender, an arm, and a quick attach coupler. The quick attach coupler interconnects one end of the arm with the fender or frame. An opposite end of the arm is rigidly connected with the other of the fender or frame.

### FIELD OF THE INVENTION

The present invention relates to work vehicles such as agricultural tractors, and, more particularly, to fender assemblies for use with such work vehicles.

### BACKGROUND OF THE INVENTION

A work vehicle such as an agricultural tractor may be wheel or track driven. In the case of a wheeled tractor, the motive force can be by two wheel drive (typically the rear wheels), front wheel assist (full time rear wheel engagement and part time front wheel engagement), or four wheel drive. A two wheel drive tractor includes two large diameter rear wheels and two smaller diameter front wheels. The rear wheels are typically covered by fenders to prevent soil from kicking back up onto the tractor, cab and/or operator. Since the front wheels are not driven, soil typically does not kick up onto the tractor, cab and/or operator and fenders are typically not used over non-driven front wheels. A four wheel drive tractor typically has a center articulated steering configuration and all four wheels (or eight in the case of duals) are of a large diameter. A four wheel drive tractor typically does not include fenders over the large diameter front wheels. A front wheel assist driven tractor includes driven front wheels which can throw soil onto the tractor, cab and/or operator; thus, many operators find it desirable to use fenders over the front wheels of a front wheel assist driven tractor.

Another option which may be desirable for a given tractor is a front end loader. The loader is bolted to the frame of the tractor, typically to the frame rails beneath the engine and the rear axle, and driven by auxiliary hydraulics using a joystick or other type lever. Various attachments such as a bucket, pallet forks, hay forks, etc. can be attached and used with the loader frame.

When using a tractor with a front end loader, the fenders over the front wheels may contact the loader frame, boom and/or lift cylinder when the front wheels are turned to a maximum extent. One solution is to use smaller front wheels and corresponding fenders; however, this solution may not be desirable.

Another problem with using front wheel fenders in conjunction with a front end loader is that servicing of the engine and other components within the engine compartment becomes difficult. The engine hood typically may be removed or pivoted upward and out of the way for servicing. The loader frame is substantial to support the heavy weights which may be lifted with the loader, and thus the frame occupies a substantial portion of the area along side of the engine. Further, the fenders are positioned with a clearance distance above the front tires, and the top of the fenders may be at about waist to chest high on an operator. If service within the engine compartment is necessary, the operator must sometimes lie over the fender and reach through the loader frame to reach a desired component for servicing, which of course is somewhat awkward.

What is needed in the art is a fender assembly for a tractor which may be easily removed for easy access to and/or servicing within the engine compartment.

### SUMMARY OF THE INVENTION

The invention comprises, in one form thereof, a work vehicle including a frame and a fender assembly. The fender assembly includes a fender, an arm attached to the frame, and a quick attach coupler which removably interconnects the fender with the arm.

The invention comprises, in another form thereof, a fender assembly for use with a work vehicle. The fender assembly includes a fender, an arm for mounting the fender to the work vehicle, and a quick attach coupler which removably interconnects the fender with the arm.

The invention comprises, in yet another form thereof, a work vehicle including a frame and a fender assembly. The fender assembly includes a fender, an arm, and a quick attach coupler. The quick attach coupler interconnects one end of the arm with the fender or frame. An opposite end of the arm is rigidly connected with the other of the fender or frame.

### BRIEF DESCRIPTION OF THE DRAWINGS

FIG. 1 is a perspective view showing a portion of a work machine in the form of an agricultural tractor, including an embodiment of a removable fender assembly of the present invention;

FIG. 2 is another perspective view of a fender assembly of the present invention;

FIG. 3 is a perspective, fragmentary view of the quick attach coupler used with the fender assembly in FIG. 2, in an assembled state; and

FIG. 4 is a perspective, fragmentary view of the quick attach coupler shown in FIG. 3, in a disassembled state

### DETAILED DESCRIPTION OF THE INVENTION

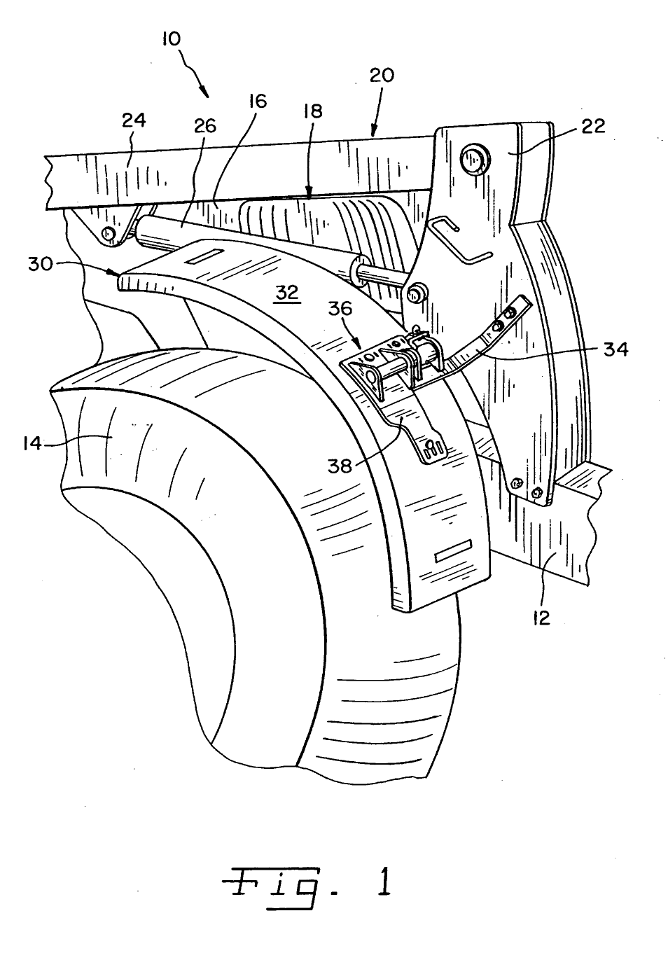

Referring now to the drawings, and more particularly to FIG. 1, there is shown a work vehicle 10 in the form of an agricultural tractor. Tractor 10 includes a frame 12 carrying a front axle, which in turn rotatably carries a pair of front wheels 14, one of which is shown. Front wheels 14 are configured with front wheel assist, also known as Mechanical Front Wheel Drive (MFWD). Front wheels 14 typically have a larger diameter in comparison with two wheel drive tractors, primarily for traction and soil compaction reasons.

Frame 12 also carries an internal combustion engine, such as a diesel or gas engine, housed within a hood 16 defining an engine compartment 18 surrounding the engine.

Frame 12 further carries a front end loader 20, including a loader frame 22 extending upward on either side of the engine compartment, a pair of booms 24 pivotally coupled with loader frame 22 on either side of the engine compartment, and a pair of lift cylinders 26 interconnecting frame 22 with a respective boom 24. A loader attachment (not shown), such as a bucket, pallet forks or hay forks, is typically attached to the outboard or forward end of front end loader 20. The bottom end of loader frame 22 can be configured as a single piece which is non-detachable from tractor frame 12, or may be configured as a multiple piece loader frame if configured as a detachable front end loader.

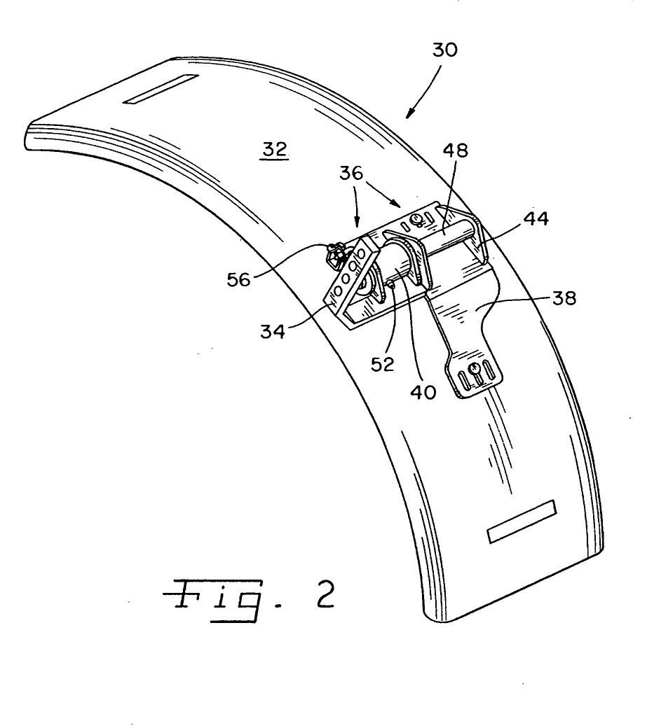

A pair of fender assemblies 30 (FIGS. 1 and 2) are positioned above a corresponding front wheel 14, with each fender assembly 30 being substantially the same. Each fender assembly 30 includes a fender 32, an arm 34 and a quick attach coupler 36. Arm 34 is rigidly attached to loader frame 22 at one end thereof, such as by using bolts. Quick attach coupler 36 allows quick attachment and detachment between fender 32 and arm 34, without the use of tools. This allows fender 32 to be quickly removed for access to or servicing of a selected component within engine compartment 18.

In the embodiment shown, arm 34 of fender assembly 30 is rigidly attached to loader frame 22. Thus, fender assembly 30 does not rotate with front wheel 14. However, the term “frame” is broadly defined herein as corresponding to any structural component of the tractor and/or front end loader to which fender assembly 30 can be mounted. For example, arm 34 can be rigidly attached to tractor frame 12, an axle or a wheel hub.

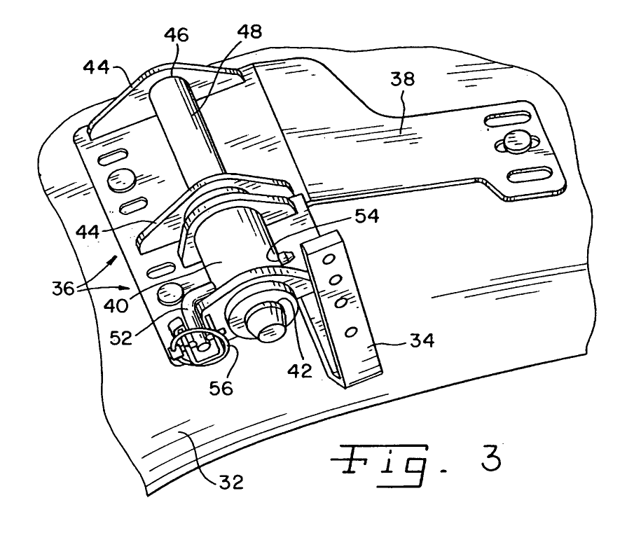

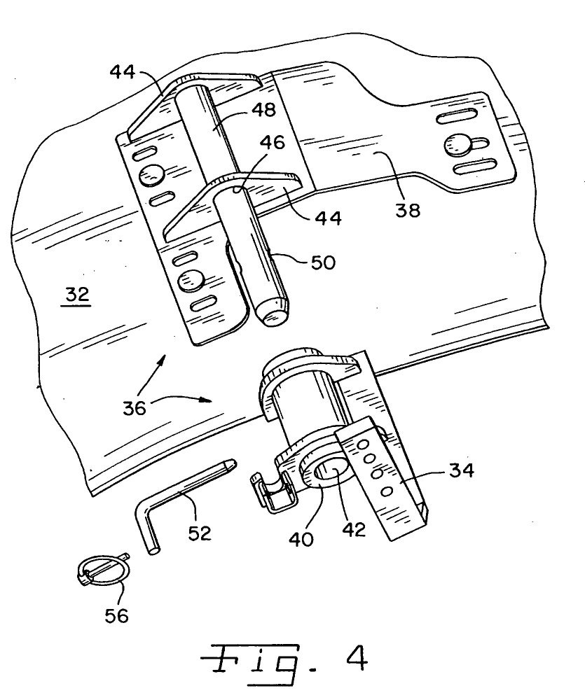

Quick attach coupler 36, shown more closely in FIGS. 3 and 4, includes a bracket 38 rigidly attached to fender 32. Bracket 38 is sized to provide sufficient surface area for attachment with fender 32, which may be made from a relatively flexible plastic to withstand minor impacts with items in a field, woodlot, etc, such as a tree branch or the like.

Arm 34 includes a bushing 40 which is rigidly attached at an outboard end thereof. Bushing 40 includes an opening 42, and bracket 38 includes a pair of ears 44, each having an opening 46. A removable pin 48 extends through openings 46 in each ear 44, and through opening 42 in bushing 40. Pin 48 thus interconnects bracket 38 with arm 34.

To lock fender 32 in place, pin 48 includes a hole 50 at a distal end thereof. A locking pin 52 extends through a radial bore 54 in bushing 40 and into hole 50 of pin 48. Locking pin 52 can be generally L-shaped, as shown, and moved to the locking position shown in FIGS. 1-3. A keeper pin 56 holds locking pin 52 at a fixed orientation relative to arm 34.

Having described the preferred embodiment, it will become apparent that various modifications can be made without departing from the scope of the invention as defined in the accompanying claims.

1. A work vehicle, comprising:
a frame; and
a fender assembly including a fender, an arm attached to said frame, and a quick attach coupler which removably interconnects said fender with said arm.

2. The work vehicle of claim 1, wherein said frame comprises one of:
a loader frame;
a vehicle frame;
an axle; and
a wheel hub.

3. The work vehicle of claim 1, wherein said quick attach coupler includes a bracket rigidly attached to said fender, and a removable pin interconnecting said bracket with said arm.

4. The work vehicle of claim 3, wherein said arm includes a bushing having an opening, and said bracket includes a pair of ears each having an opening, said pin extending through said openings in each said ear and through said opening in said bushing.

5. The work vehicle of claim 4, wherein said pin includes a hole at a distal end thereof, and further including a locking pin extending through said hole to lock said pin in place.

6. The work vehicle of claim 5, wherein said bushing includes a radial bore, and said locking pin extends through said radial bore into said hole in said pin.

7. The work vehicle of claim 6, wherein said locking pin is generally L-shaped, and further including a keeper pin holding said locking pin at a fixed orientation relative to said arm.

8. The work vehicle of claim 1, wherein said quick attach bracket is configured to allow attachment and detachment of said fender with said arm without the use of tools.

9. A fender assembly for use with a work vehicle, comprising:
a fender;
an arm for mounting said fender to the work vehicle; and
a quick attach coupler which removably interconnects said fender with said arm.

10. The fender assembly of claim 9, wherein said quick attach coupler includes a bracket rigidly attached to said fender, and a removable pin interconnecting said bracket with said arm.

11. The fender assembly of claim 10, wherein said arm includes a bushing having an opening, and said bracket includes a pair of ears each having an opening, said pin extending through said openings in each said ear and through said opening in said bushing.

12. The fender assembly of claim 11, wherein said pin includes a hole at a distal end thereof, and further including a locking pin extending through said hole to lock said pin in place.

13. The fender assembly of claim 12, wherein said bushing includes a radial bore, and said locking pin extends through said radial bore into said hole in said pin.

14. The fender assembly of claim 13, wherein said locking pin is generally L-shaped, and further including a keeper pin holding said locking pin at a fixed orientation relative to said arm.

15. The fender assembly of claim 9, wherein said quick attach bracket is configured to allow attachment and detachment of said fender with said arm without the use of tools.

16. A work vehicle, comprising:
a frame; and
a fender assembly including:
a fender;
an arm; and
a quick attach coupler at one end of said arm and interconnecting said arm with one of said fender and said frame, an opposite end of said arm being rigidly connected with an other of said fender and said frame.

17. The work vehicle of claim 16, wherein said frame comprises one of:
a loader frame;
a vehicle frame;
an axle; and
a wheel hub.

18. The work vehicle of claim 16, wherein said quick attach coupler includes a bracket rigidly attached to said fender, and a removable pin interconnecting said bracket with said arm.

19. The work vehicle of claim 18, wherein said arm includes a bushing having an opening, and said bracket includes a pair of ears each having an opening, said pin extending through said openings in each said ear and through said opening in said bushing.

20. The work vehicle of claim 19, wherein said pin includes a hole at a distal end thereof, and further including a locking pin extending through said hole to lock said pin in place.

21. The work vehicle of claim 20, wherein said bushing includes a radial bore, and said locking pin extends through said radial bore into said hole in said pin.

22. The work vehicle of claim 21, wherein said locking pin is generally L-shaped, and further including a keeper pin holding said locking pin at a fixed orientation relative to said arm.

23. The work vehicle of claim 16, wherein said quick attach bracket is configured to allow attachment and detachment of said fender with said arm without the use of tools.
